(19) United States
(12) Patent Application Publication
(10) Pub. No.: US 2015/0036551 A1
(43) Pub. Date: Feb. 5, 2015

(54) TELETRIAGE SYSTEM AND ASSOCIATED METHODS FOR COMMUNICATION BETWEEN EMERGENCY RESPONDERS AND MEDICAL SUPPORT

(71) Applicant: Peter A. PAPPAS, Winter Park, FL (US)

(72) Inventor: Peter A. PAPPAS, Winter Park, FL (US)

(21) Appl. No.: 14/450,909

(22) Filed: Aug. 4, 2014

Related U.S. Application Data
(60) Provisional application No. 61/862,220, filed on Aug. 5, 2013.

(51) Int. Cl. H04W 4/22; H04M 3/56

(52) U.S. Cl. CPC H04W 4/22; H04M 3/567; H04W 88/16
USPC 370/260

(57) ABSTRACT

A system and method for providing an integrated telemedicine/network for coordinating emergency medical response treatment by and among Fire/EMS, law enforcement, emergency rooms, field deployed triage units, trauma centers, municipal, county and State leadership using secure communications devices and servers accessed by and linked to at least one mobile transmission devices.

### PRIORITY CLAIM

This application claims priority to provisional application Ser. No. 61/862,220 filed on Aug. 5, 2013, the contents of which are incorporated by reference.

### BACKGROUND OF THE DISCLOSURE

1. Field of Disclosure

The present disclosure relates generally to systems and methods for communication between a field deployed emergency response team and at least one medical support station of a telemedicine network, and in particular, the present disclosure is directed to a teletriage/mobile emergency care system and method that may include, for example, providing audio and/or video bidirectional communications between a field deployed emergency response team and at least one medical support station to permit real time access to assistance in the diagnosis, care, education and treatment of patients.

2. Description of Related Art

Trauma surgeons and field deployed emergency response teams (first responders) plan patient care around a principle called the “golden hour.” The golden hour is commonly understood to mean that actions taken and decisions made within the first sixty (60) minutes after traumatic injury are crucial to obtaining the best possible outcome for a patient's recovery. Conventionally, first responders would have to diagnose, care for, and treat injured patients without access to assistance from medical personnel who are more knowledgeable about various conditions and/or clinical procedures. More recently, first responders have been able to contact emergency personnel through either a cell phone or a laptop computer so as to receive assistance in treating injured. Disadvantageously, such connections are based upon an individual connection and do not provide either the first responder or the medical support with a complete data set of information which may be used to best care for the patient. Thus, in the case of large scale trauma events, where multiple patients are presented, there is no manner of monitoring and coordinating the medical treatment effort. Accordingly, immediate access to medical support personnel, such as trauma surgeons, by first responders is oftentimes desired. Further, real time or near real time audio and visual connections to a remote trauma center and/or a central command station is desired as the same provides a more complete data set for assessing injuries and proscribing treatments for injured patients. Still further, it is desired to provide both visual and audio bidirectional communications between a medical command/trauma surgeon and first responders to assist in the effective treatment of critical injuries sustained by patients until the patient can be transferred to a medical facility.

### SUMMARY OF THE INVENTION

The system and method of the present disclosure overcomes the shortcomings of conventional systems and methods by providing a teletriage network comprising at least one mobile communication device or unit that is communicably linked or connected to a central medical monitoring network having at least one computing server which is adapted for providing and collecting data that is time- and date-sensitive. In example embodiments, the system and methods provide a secure, portable, accessible, redundant, reliable, operational, woven network (SPARROW network) of medical and law enforcement divisions which cooperate to provide and oversee treatment and care of injured patients in the field. In all example embodiments, the present disclosure is directed to a SPARROW network for interconnecting first responders with at least one central monitoring station and at least medical support station so as to monitor and assist the first responders in providing in field medical treatment to injured patients. Further, the SPARROW network is operable for providing immediate medical information, such as education, data, records, etc. to first responders who are treating patients during the golden hour. In exemplary embodiments, the mobile transmission unit is a Smartphone or similar device configured to connect to a mobile web application that interconnects with a plurality of remote stations. In all exemplary embodiments, the mobile transmission device is provided with audio and video transmitting and receiving capabilities to facilitate audio and/or video conferencing.

In exemplary embodiments, the SPARROW network system includes one or more mobile transmission devices communicably linked or connected to a central computing server of a central medical monitoring network for bidirectional communication. The one or more mobile transmission devices may also be communicably linked or connected to a medical station, such as a trauma center or a trauma surgeon. The bidirectional communications are preferably over the Internet using a secure protocol. Where the mobile device is a cell phone, a smartphone or a tablet device, a gateway may be provided to communicate data and transmissions from the mobile device to the provider network. The mobile device may be provided with software, hardware, or firmware which includes various modules or features to allow the mobile device to act as a client device with respect to the central medical monitoring network. The mobile device may connect to the central medical monitoring network and download a mobile web application related to medical care. Alternatively, the mobile device may include one or more resident applications and associated data storage that can be configured to provide one or more of the modules or features. In example embodiments, one or more mobile transmission devices, may be communicably linked, through a communication network, to a central monitoring station, a medical support station and a law enforcement station.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

The present subject matter may take form in various components and arrangements of components, and in various steps and arrangements of steps. The appended drawings are only for purposes of illustrating exemplary embodiments and are not to be construed as limiting the subject matter.

FIG. 1 is a schematic system diagram illustrating an exemplary SPARROW network system constructed in accordance with an exemplary implementation of the present disclosure;

FIG. 2 is a schematic system diagram illustrating an exemplary SPARROW network system connection between a single mobile transmission device and a central monitoring station constructed in accordance with an exemplary implementation of the present disclosure;

FIG. 3 is a schematic system diagram illustrating an exemplary SPARROW network system constructed in accordance with an exemplary implementation of the present disclosure;

FIG. 4 is a schematic system diagram illustrating an exemplary SPARROW network system constructed in accordance with an exemplary implementation of the present disclosure; and

FIG. 5 is a schematic system diagram illustrating an exemplary SPARROW network system for responding to a mass casualty event constructed in accordance with an exemplary implementation of the present disclosure.

### DETAILED DESCRIPTION OF PREFERRED EMBODIMENTS

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As stated above, the system and method of the present disclosure overcomes the shortcomings of conventional systems and methods by providing a SPARROW network or a central medical monitoring network which includes at least one mobile transmission device or unit that is configured to connect to a network server or an enterprise network (hereinafter “network”) via a mobile web application and is also adapted for transmitting to and receiving data from the network and for collecting medical data that is time- and date-sensitive related to a patient located at a remote site and being attended to by first responders. Further, the system and method of the present disclosure overcomes the shortcomings of conventional systems and methods by providing the ability to send and receive audio and video communications to and among first responders, a central monitoring station, at least one medical support station or personnel, such as a trauma center or a law enforcement station, or any combination thereof. Still further, the system and method of the present disclosure overcomes the shortcomings of conventional systems and methods by providing the ability to assist first responders in the diagnosis and treatment of patients during the golden hour. Still further, the system and method of the present disclosure overcomes the shortcomings of conventional systems and methods by providing the ability to assist first responders by providing them with medical education information relative to potential injuries incurred by patients.

Advantageously, the present disclosure provides a system sand method which 1) provides first responders with real time or near real time access to an intelligence incident command or central command station which monitors events; 2) provides first responders with trauma center support for the care and treatment of patients in the field; 3) provides real time or near real time access to medical support personnel; 4) provides improved real time or near real time casualty and triage of patients in the field; and 5) provides an integrated telemedicine/network for coordinating emergency medical response treatment by and among Fire/EMS, law enforcement, emergency rooms, field deployed triage units, trauma centers, municipal, county and State leadership using secure communications devices and servers accessed by and linked to at least one mobile transmission devices.

In all example embodiments, the present invention is directed to a system and method for a teletriage network which is comprised of at least one mobile transmission device or unit, at least one central monitoring station and at least one medical support station connected via a communicating network. In example embodiments, the method and system includes at least one computing server system communicably and bidirectionally linked to a client device or mobile device. In example embodiments, the system and method includes a mobile web application which includes various modules related to network, for example, audio conferencing module, video conferencing module, data storage and retrieval module, scheduling module, routing module and monitoring module. In example embodiments, once a first responder accesses the application, he/she is connected to a central monitoring station which can then connect the first responder to an appropriate medical support station or personnel to assist in the diagnosis, care, and treatment of an injured patient. Thereafter, the medical support personnel may communicate with the first responder through either an audio connection, a video connection or both so as to provide a complete data set relating to the patient condition. Further, the provision of the audio and video connection will enable the medical support personnel to instruct the first responder in the treatment and handling of the patient until the patient can be transferred to a medical facility. This may include, for example, educational training demonstrations.

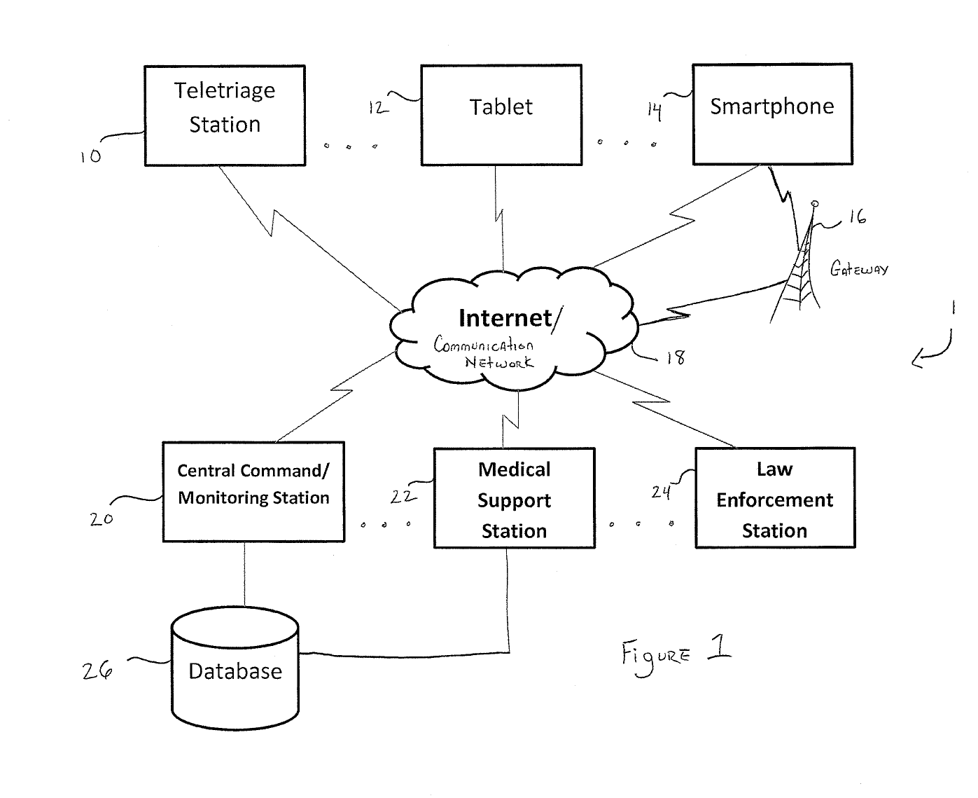

Referring now to FIG. 1, a teletriage network 1 with a mobile communication device or unit that is communicably linked or connected to a central medical monitoring network having at least one computing server and is adapted for providing and collecting medical data that is time- and date-sensitive. In example embodiments, the system and methods provide a secure, portable, accessible, redundant, reliable, operational, woven network (SPARROW network) of medical and law enforcement divisions which cooperate to provide and oversee treatment of injured patients in the field through at least one first responder. As illustrated, the teletriage network 1 includes at least one teletriage station 10 bidirectionally linked to a central command/monitoring station 20 via a communication network 18. In exemplary embodiments, more than one teletriage station 10 may be included in the network 1 and may comprise a tablet 12, a smartphone 14 and the like. Further, in exemplary embodiments, the teletriage station 10 may be bidirectionally linked to a medical support station 22 and a law enforcement station 24 in addition to the central command station 20. In exemplary embodiments, each of the central command station and the medical support station may be communicably linked to a database 26 for retrieving and storing medical information related to clinical treatments and/or patient information. In still other exemplary embodiments, in the case of a smartphone 14, a gateway 16 may be used as a connection to the communication network 18.

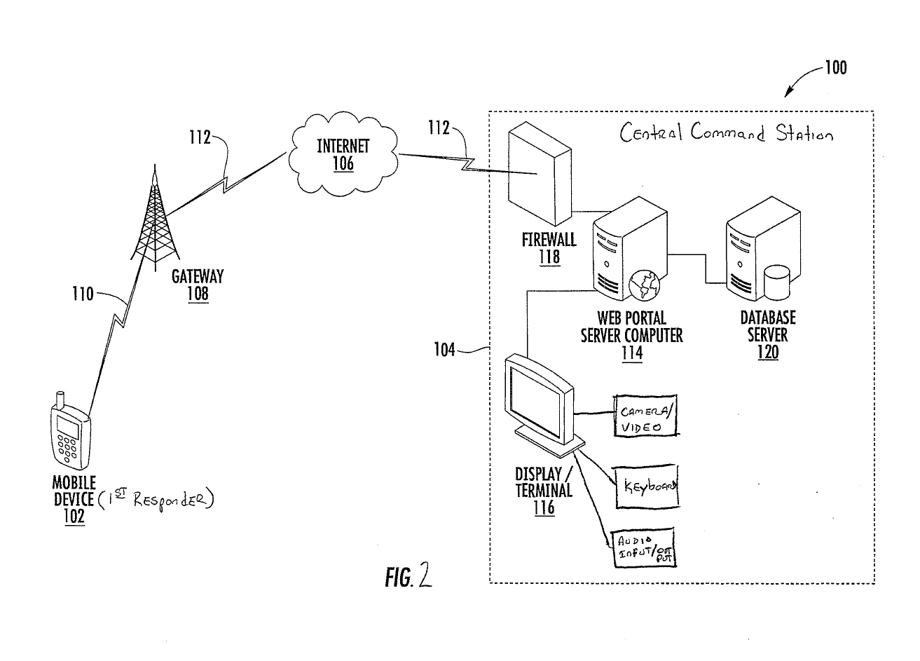

Referring now to FIG. 2, one example embodiment of a SPARROW system and network 100 is shown. As shown, the SPARROW system and network may include one or more mobile transmission devices 102 that may be used by a first responder to bidirectionally communicate 110, 112 with a central command station server system 104. In one or more embodiments, the mobile transmission device 102 may comprise a lap top computer, a personal computer (PC), a cell phone, a Smartphone, or a multi-touch device having a touch sensing surface (e.g., track pod or touch screen) with the ability to recognize the presence of two or more points of contact with the surface. Examples of a multi-touch devices include mobile devices (e.g., iPhone™, Nexus™ Android™ devices, etc.), tablet computers (e.g., iPad™, Surface™, Galaxy Tab™, HP Touchpad™), portable/handheld game/music/video player/console devices (e.g., iPod Touch™, MP3 players, Nintendo 3DS™, PlayStation Portable™, etc.), touch tables, visual control devices (e.g., Google Glass™), and walls (e.g., where an image is projected through acrylic and/or glass, and the image is then backlit with LEDs). In other example embodiments, the bidirectional communications 112 are preferably over the Internet 106, which the mobile device 102 may access through a gateway 108. As will be appreciated by those skilled in the art, the bidirectional communications 112 may be via any communications network (which may be either of, or a combination of a fixed-wire or wireless LAN, WAN, intranet, extranet, peer-to-peer network, virtual private network, the Internet, or other communications network) with a number of client computing environments such as tablet personal computer, mobile telephone, telephone, personal computer, and personal digital assistance. In a network environment in which the communications network is the Internet 106, for example, the provider network 104 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Additionally, the networked computing environment can utilize various data security protocols such as HTTPS (HyperText Transfer Protocol with SSL (Secure Socket Layer) encryption for security) or pretty good privacy (PGP). Each client computing environment can be equipped with operating system operable to support one or more computing applications, such as a web browser such as MICROSOFT INTERNET EXPLORER™, MOZILLA FIREFOX™, OPERA™, APPLE SAFARI™, etc. (not shown), or other graphical user interface (not shown), or a mobile desktop environment (not shown) to gain access to server computing environment. In example embodiments, the software executing on client devices may be downloaded from the server computing environment and installed as a plug in or ACTIVEX™ control of a web browser.

Where the mobile device 102 is a cell or smartphone phone, the gateway 108 may comprise a cellular tower, base station, and Internet gateway, so that the mobile device 102 communicates with the gateway 108 via a cellular signal 110. Other alternatives for facilitating wireless bidirectional communications could call for the gateway 108 being a wireless gateway at a private or municipal WiFi access point. The particular implementation of the bidirectional communication link between the mobile device 102 and the server system 104 may vary depending on what systems are available in the relevant region being serviced. The frequency of data transmissions will depend on the particular activity that is in process.

In example embodiments, the mobile device 102 is preferably a small (easily portable) wireless device that includes at least a display, an imaging device, such as a digital camera and/or a video camera, a microphone system, a speaker system, and a data entry mechanism, such as a keypad, keyboard, touchscreen, and/or voice-recognition input system. Other physical features that may be included as part of the mobile device 102 are (a) a transceiver, such as a cellular phone and/or wireless modem (data transmissions would preferably made using a cell phone's data plan), (b) a GPS (Global Positioning System) module, (d) an RFID (Radio-Frequency Identification) module, and/or (e) a Bluetooth (or other PAN (Personal Area Network) module. The mobile device 102 is preferably carried by first responders that operate in the field.

To provide the functionality afforded by various embodiments of the present invention, the mobile device 102 preferably includes software, hardware, firmware, or a combination of these, to allow the mobile device 102 to act as a client device with respect to the central command station 104. As such, the mobile device preferably includes one or more resident software applications and associated data storage. Such features may be supported by a set of application components written in programming languages such as mobile computing languages (e.g. Asp.Net 4-MVC 3, HTML5, jQuery Mobile, J2ME or BREW), running on the mobile device 102.

The central command station 104 in the illustrated embodiment includes a web portal server computer 114 and one or more associated displays 116, a firewall 118, one or more database servers 120, and a billing/accounting system 122. The central command station 104 may be a centralized nation-wide central system that provides administration services for several or many first responders in different regions. Alternatively, one or more dedicated central command stations 104 may be employed throughout various regions. Multiple command stations 104 and/or multiple components within the command station 104 may be included in order to provide redundancy and/or load balancing.

The server computer 114 acts as a server to the mobile device 102 and is preferably provided with a software based web server application that performs many actions such as dynamically managing communications and connections by and among first responders and medical support personnel located at a medical support station such as a trauma center and/or law enforcement personnel located at a law enforcement station with the mobile device 102. Since bidirectional communications with the mobile device 102 are preferably made over the Internet 106, the server computer 114 is preferably connected to the Internet 106 through the firewall 118.

In example embodiments, the one or more displays/terminals 116 may be used with the central command station 104. Examples of such devices 116 include desktop PCs, laptop computers, Tablet PCs, workstations, or any computer devices running on any Operating System that can connect to a World Wide Web server, retrieve, and display web pages. In example embodiments, a camera/video input/out system is included in the device 116. Further, a data entry (e.g., keyboard) and audio input/output system is included.

In example embodiments, the database server 120 may configured to store various types of data that provide assistance in the treatment and care of injured persons, such as medical records and field service, clinical procedures. The database server 120 may be one or more databases are preferably of any RDBMS (Relational Database Management System) based.

In example embodiments, the SPARROW network may include an enterprise application integration module. The enterprise application integration module may be included in the system 100 if the system 100 will be integrated with applications from third parties, such as a medical station and a law enforcement station. The enterprise application integration module includes application components that are designed to communicate with other systems and has features to support multiple communication protocols, including, without limitation, HTTP, FTP, and Secure FTP. Possible data structures that may be embodied in such communication protocols include HL7, XML, CSV, and other formats. The module is flexible to support real-time communication and file batch communication. The enterprise application integration module also includes a data mapping utility that maps incoming data messages from the third party format into its own data format that the database server 120 supports.

For example, the enterprise application integration module would allow that third-party application to integrate and interoperate with applications on the server computer 114 and/or the database server 120. This may enable administrators to view integrated and complementary views of medical information. Other third-party applications that might be partly or entirely integrated into the system 100 using the enterprise application integration module are a clinical medicine database application. The information exchanged between the enterprise application integration module and third-party applications may be exchanged in real-time or near real-time, for example.

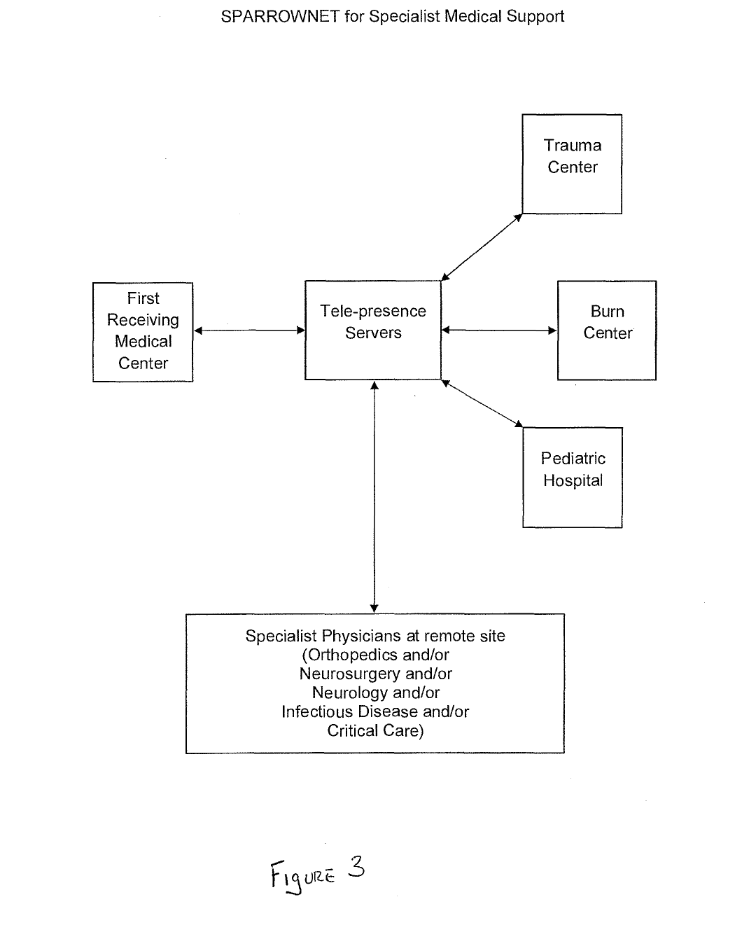

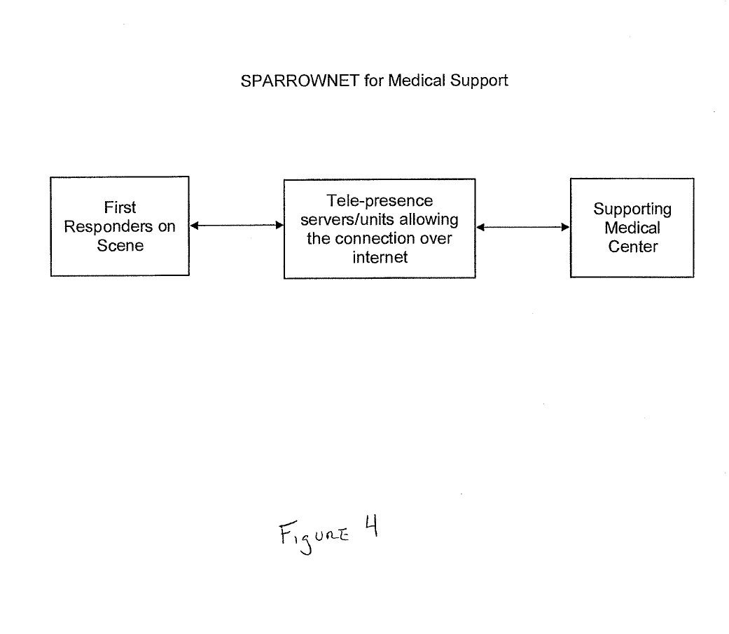

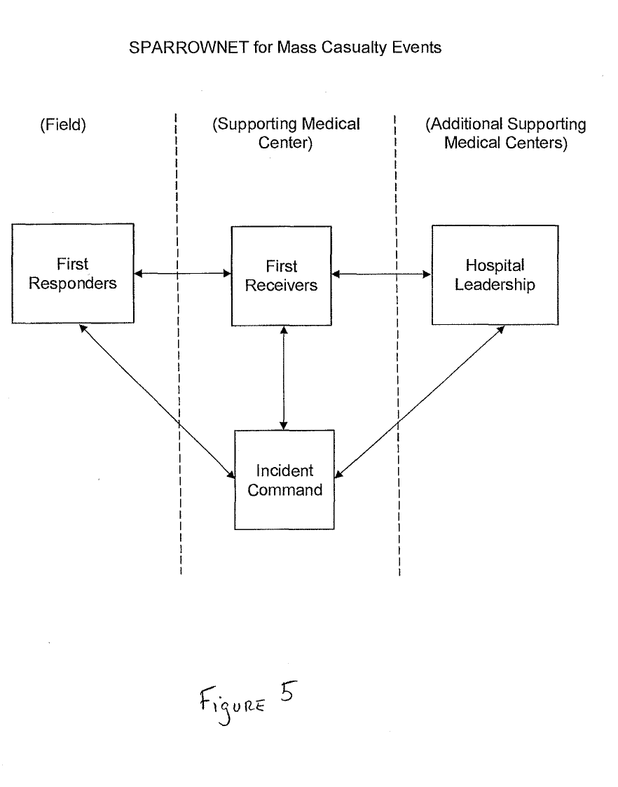

Referring now to FIGS. 3-5, various solutions and example embodiments for the disclosed system are shown. For example, FIG. 5 illustrates a use of the disclosed system in response to a mass casualty event. Such an event would have the first responders connect with the central command station and Medical support. In an instance where additional support would be required, additional connections can be made and brought into the communication system. Referring now to FIG. 3, an example embodiment of the disclosed system is shown. As shown, a first receiving medical center which receives injured patients may connect via tele-presence servers/Internet to any one of a trauma center, a burn center, a pediatric center, a specialist physician located at a remote site, or the like. Referring now to FIG. 4, another example embodiment of the system is shown. As shown, a first responder could connect directly to a medical support center via tele-presence servers/Internet.

As will be appreciated by one skilled in the art, embodiments and aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages such as those listed herein above or those including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network such as those previously identified hereinabove.

Aspects and embodiments of the present disclosure are described above with reference to illustrations and/or block diagrams of methods, apparatus (systems) and computer program products according to embodiments of the disclosure. It will be understood that each illustration and/or block diagrams, and combinations thereof, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the illustrations and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the illustrations and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the illustrations and/or block diagram block or blocks.

The illustrations and block diagrams in the Figures illustrate the architecture, functionality and operation of possible implementations of systems, methods and computer program products according to various embodiments of the present disclosure. In this regard, each illustration or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or illustration, and combinations of blocks in the block diagrams and/or illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, it will be understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

The embodiments described above provide advantages over conventional systems and methods. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Furthermore, the foregoing description of the preferred embodiments of the invention and best mode for practicing the invention are provided for the purpose of illustration only and not for the purpose of limitation—the invention being defined by the claims.

What is claimed:

1. A teletriage system, comprising:
a central command server network accessible via a communication network and comprising at least one communication application module for assisting a first responder in the diagnosis, treatment and care of an injured patient, said at least one application comprising audio and video conferencing capabilities;
at least one mobile transmission device configured to bidirectionally communicate with the central command server network via the communication network,
at least one medical support station configured to bidirectionally communicate with both the central command server network and the at least one mobile transmission device,
wherein the central command server network coordinates communications between the medical support station and the at least one mobile transmission device such that the first responder may diagnose, treat and care for an injured patient in the field.

2. The teletriage system of claim 1 wherein the communication occurs across a secure, portable, accessible, redundant, reliable operational woven network.

3. The system of claim 1 wherein the teletriage unit is a smart phone or a tablet computer.

4. The system of claim 3 further including a gateway for access to the communication network.

5. The system of claim 4 where in the gateway is selected from a cellular tower, a base station or an internet gateway.

6. The system of claim 1 wherein the mobile transmission device is selected from the group consisting of: a personal computer, a lap top computer, a cell phone, a smart phone, a tablet computer, a multi touch device, touch tables, visual control devices or walls.

7. The system of claim 1 wherein the bidirectional communications takes place over the internet.

8. The system of claim 1 wherein the at least one mobile transmission device comprises:
a display;
an imaging device;
a microphone system;
a speaker system;
a data entry mechanism; and
a touch screen.

9. The system of claim 1 wherein the at least one mobile transmission device further comprises at least one of the following: a means for voice recognition, a GPS module; an RFID module, or a Bluetooth module.

10. The system of claim 1 wherein the mobile transmission device serves as a client device to the central command station.

11. The system of claim 10 wherein the mobile transmission device further comprises resident software applications and data storage.

12. The system of claim 1 wherein the central command station comprises a web portal server computer having at least one associated display, a firewall, at least one database server, and a billing/accounting system.

13. The system of claim 1 wherein the web portal sever computer is a server to the mobile transmission device.

14. The system of claim 1 wherein the central command station provides administration for more than one mobile transmission device.

15. A teletriage system, comprising:
a central command server network accessible via a communication network and comprising at least one communication application module for assisting a first responder in the diagnosis, treatment and care of an injured patient, said at least one application comprising audio and video conferencing capabilities; wherein the central command station comprises a web portal server computer having at least one associated display, a firewall, at least one database server, and a billing/accounting system;
at least one mobile transmission device configured to bidirectionally communicate with the central command server network via the communication network, wherein the mobile transmission device comprises:
a display;
an imaging device;
a microphone system;
a speaker system;
a data entry mechanism; and
a touch screen;
at least one medical support station configured to bidirectionally communicate with both the central command server network and the at least one mobile transmission device,
wherein the central command server network coordinates communications between the medical support station and the at least one mobile transmission device such that the first responder may diagnose, treat and care for an injured patient in the field; and
wherein the communication occurs across a secure, portable, accessible, redundant, reliable operational woven network.

16. The system of claim 15 wherein the teletriage unit is a smart phone or a tablet computer.

17. The system of claim 16 further including a gateway for access to the communication network.

18. The system of claim 15 wherein the central command station comprises a web portal server computer having at least one associated display, a firewall, at least one database server, and a billing/accounting system.

19. The system of claim 15 wherein the web portal sever computer is a server to the mobile transmission device.

20. The system of claim 15 wherein the central command station provides administration for more than one mobile transmission device.
